(19) United States
(12) Patent Application Publication
(10) Pub. No.: US 2013/0263758 A1
(43) Pub. Date: Oct. 10, 2013

(54) STABILIZED RED MUD AND METHODS OF MAKING THE SAME

(71) Applicants: Charles Skoda, Brentwood, TN (US); Steven Birdwell, Houston, TX (US)

(72) Inventors: Charles Skoda, Brentwood, TN (US); Steven Birdwell, Houston, TX (US)

(21) Appl. No.: 13/859,699

(22) Filed: Apr. 9, 2013

Related U.S. Application Data
(60) Provisional application No. 61/622,071, filed on Apr. 10, 2012.

(51) Int. Cl. C04B 18/04

(52) U.S. Cl. CPC C04B 18/0409
USPC 106/286.3

(57) ABSTRACT

A stabilized red mud composition containing red mud generated as a by-product of the Bayer process reduced to a water content of less than or equal to about 65% and an effective amount of an ash composition to convert the red mud and its water content into a reaction product suitable as a construction material and methods of making the same.

### TECHNICAL FIELD

This application is directed to stabilized red mud, and more particularly, to its composition, methods of formation, and use as a building material for structures such as levees, dikes, and landfill material.

### BACKGROUND

Bauxite ore is one of the most important ores of aluminum, and comprises approximately 30-50% alumina. The most common industrial method of extracting alumina from bauxite ore is known as the Bayer process. In the Bayer process, the bauxite is crushed, slurried with a solution of sodium hydroxide, and pumped into large pressure tanks, or digesters. The bauxite is subjected to steam heat and pressure in the digesters, and this caustic leaching process slowly dissolves the alumina where it reacts with the sodium hydroxide to form a saturated solution of sodium aluminate. The solution containing the sodium aluminate is placed in a special tank where the alumina is precipitated out of the solution. The insoluble residue that remains, which is bauxite ore from which the alumina has been extracted, is the source material for the present application.

Bauxite ore from which the alumina has been extracted using the Bayer process may be termed bauxite refinery residue and is commonly known as “red mud.” Red mud typically contains finely divided iron-, aluminum-, and titanium oxides and oxyhydroxides. Large amounts of sodium hydroxide and sodium carbonate are also present in the Bayer process, so red mud is typically highly caustic, unless it has been washed and filtered to remove the excess sodium hydroxide. Due to the percentage of alumina found in bauxite ore (30-50%), approximately one to two tons of red mud is generated for every one ton of alumina produced. The large quantity of red mud generated in the alumina extraction process is typically stored in disposal sites such as containment reservoirs (red mud “ponds” or “lakes”) near the refinery. Storage is presently the most economical method of handling the red mud and as such, red mud is deemed a “waste” by-product. Long term storage of red mud is a problem for refineries, especially those with limited land space for building additional red mud ponds.

Society's increasing concern with the environmentally safe disposal of industrial wastes has led to the development of a variety of processes in which some wastes are used to form, or are incorporated in a cementitious material. For example, oily sludge wastes from petroleum refining have been incorporated into a cementitious material as described in U.S. Pat. No. 5,584,792 and high water content sludge such as dredge spoils, storm water basin sludge and sediments, oil shale sludge, tar belts sludge, mining sludge, etc. are solidified to form a matrix that is capable of supporting the weight of commercial construction equipment. Upon hardening, such materials (when properly formulated) are disclosed as being suitable for disposal or for use as a construction or landfill material.

Red mud is stored in abundance in red mud ponds throughout the world. The storage time spent in the red mud ponds allows the water content of the red mud to be reduced, i.e., through natural evaporation or through intervention of man and/or machine Typically, at the end of the Bayer process red mud has a water content of about 80% or higher. On the contrary, red mud in the red mud ponds typically has a water content of about 45-65%. Accordingly, there is a need for methods and compositions for modifying red mud stored in red mud ponds, that has the reduced water content, to render the red mud suitable for use, for example, as a construction material.

### SUMMARY

In one aspect, stabilized red mud compositions are formulated that include mixing together red mud generated as a by-product of the Bayer process that has a reduced water content of less than or equal to about 65% and an effective amount of an ash composition to convert the red mud and its water content into a reaction product suitable as a construction material. The ash composition may include ash selected from ash high in alumina, ash high in sulfate, ash high in calcium, and combinations thereof and may include a CFB bed ash, a CFB fly ash, fly ash from a coal fired power plant facility, a class C fly ash, Portland cement, lime kiln dust, cement kiln dust, cement-lime, class C fly ash-lime and combinations thereof.

In one embodiment, the red mud is mixed with an ash composition that includes a mixture of class C fly ash and either CFB bed ash or CFB fly ash. This ash composition may include class C fly ash as about 30% to about 50% of the composition and CFB bed ash or CFB fly ash as about 50% to about 70% of the composition and may, as a composition, be added to the red mud as about 5% to 20% by weight of relative thereto.

In another embodiment, the red mud may have its water content reduced such that the water content thereof is about 50% to about 65%. In yet another embodiment, the red mud may have its water content reduced such that the water content thereof is about 25% to about 50%.

In another aspect, methods of making the stabilized red mud composition are disclosed that include providing a quantity of red mud generated as a by-product of the Bayer process having a reduced water content of less than or equal to about 65% and mixing an effective amount of an ash composition into the provided quantity of red mud to convert the red mud and its reduced water content into a reaction product suitable as a construction material.

The ash composition used in the method may have the composition discussed above or below and may be present as about 5% to 20% by weight of the resulting stabilized red mud composition and the red mud may have a water content reduced to about 50% to about 65% or about 25% to about 50%.

In another aspect, water level regulating structures (such as levees, dikes, embankments, floodbanks, stopbanks, or the like) and landfill materials were developed that include a stabilized red mud. The stabilized red mud is formed by mixing together a red mud generated as a by-product of the Bayer process that has a reduced water content of less than or equal to about 65% and an effective amount of an ash composition to convert the red mud and its water content into a reaction product suitable as a construction material.

### DETAILED DESCRIPTION

A stabilized red mud and method of making the stabilized red mud have been developed. The stabilized red mud is beneficial as a construction material for water retention or water level regulating structures such as levees, dikes, embankments, floodbanks, stopbanks, or the like or as a landfill material for sub-grades, landfill liners, landfill caps, landfill daily cover, or as general fill material. Use of the red mud for such purposes is an extremely important step toward reducing the amount of this by-product stored at facilities that use the Bayer process, which is more cost efficient than storing millions of cubic yards of red mud in ponds.

As used herein, “red mud”, or bauxite residue, is a waste/by-product produced when bauxite is refined using the Bayer process to produce alumina.

As used herein, “construction material” means a material that can be moved, excavated, and/or handled using conventional excavating and material handling equipment and that is suitable for building underground or above ground structures including, but not limited to, levees, dikes, embankments, floodbanks, stopbanks, sub-grades, landfill liners, landfill daily cover, landfill caps, and as a general land fill.

In one embodiment, the stabilized red mud has a formulation that is approved by the United States Army Corp of Engineers as a construction material and/or the Louisiana Department of Environmental Quality as a construction material. Some desirable properties of the stabilized red mud as a construction material include, but are not limited to:
increased shear strength;
reduced unit weight;
low permeability (but can be modified to meet structural fill specifications by addition of sand or pisolite, another by-product of Alumina manufacturing);
low erodibility;
minimized consolidation and swell; and
minimized shrinkage.
   Furthermore the stabilized red mud construction material may be characterized per the ASTM standards below as having:
an amount of material finer than No. 200 sieve of about 32 to about 88 as determined according to ASTM D1140;
particle size in the range of about 0.0015 mm to about 0.15 as determined according to ASTM D422;
a moisture content of about 40 to about 56 as determined according to ASTM D2216;
an organic content of about 6 to about 9 as determined according to ASTM D2974;
a liquid limit of about 68 to about 80, a plastic limit of about 40 to about 51, and a plasticity index of about 17 to about 40 as determined according to ASTM D4318;
a moisture-density relationship of a soil of about 47-48 optimum moisture (%) to about 74-77 maximum dry density (pcf) as determined according to ASTM D698.
a density and unit weight by sand-cone of about 63 pcf to about 82 pcf as determined according to ASTM D1556;
a hydraulic conductivity of about 3.9×10⁻⁰⁷ to about 2.6×10⁻⁰⁸ as determined according to ASTM D5084;
a direct shear strength of at least 0.575 tsf and an angle of internal friction of about 30.6 degrees as determined according to ASTM D3080;
a pinhole dispersion equal to an ND1—Non Dispersive classification as determined according to ASTM D4647; and/or
a one-dimensional swell of about <5% increase in volume of fill as determined according to ASTM D4546.

The stabilized red mud is a reaction product formed when an effective amount of an ash composition is generally evenly mixed throughout a quantity of red mud having a reduced water content of less than or equal to about 65%. The resulting stabilized red mud is suitable as a construction material.

As mentioned in the background section, red mud exits the Bayer process with a high moisture content of about 80% or higher, typically in the form of a red mud slurry. This slurry is often stored in a red mud pond. Once the water content of the red mud is reduced to about 50-65% or lower, the red mud is utilized in forming the disclosed stabilized red mud. The water content of the red mud may be reduced by natural methods such as air drying or by mechanical methods such as heating, spreading the red mud over a larger surface area, applying an air current over the surface of the red mud, other known means of drying materials, and combinations thereof.

Increased evaporation at the surface of a red mud pond is likely to result in less than the top twelve to twenty four inches of a red mud pond, i.e., the surface layer, having a different water content than the sub-surface red mud therebelow. The surface layer may have a water content of about 35-50% and the sub-surface layer may have a water content of about 50-65%. Prior to adding the ash composition, the red mud may be mixed to homogenize the distribution of the red mud having the different water content such that overall the now mixed red mud has an overall water content of about 50-65%. It is believed that this should enable the chemical reaction between the ash composition and the red mud to occur more uniformly.

In one embodiment, the red mud's water content is reduced to a water content that is below 50%. In one embodiment, the water content of the red mud may be reduced to about 25-35%. In another embodiment, the water content of the red mud is reduced to about 35-45%, and more preferably to about 38-40%. This reduced water content may be achieved by removing red mud from a red mud pond and spreading it out to increase its surface area to promote air drying. Periodically, the red mud may be tilled, moved, and/or re-spread to again promote air drying. This process may be repeated over any number of days and weeks until achieving the desired water content. Red mud dried out in this manner may be beneficial to use on the out-board side of levees to add weight to counteract slip-plane failure, or be rehydrated in-place, removed and used to create height of existing levees. One benefit to drying the red mud to these lower water content levels is the reduced weight of the material. This is especially beneficial when the red mud is shipped from its manufacturing site to a construction site.

The red mud used in this invention is treated to reduce the pH as part of or after the Bayer process, typically to a pH of about 9 to about 10.

The ash composition mixed with the red mud to form the stabilized red mud includes suitable ash such as, without limitation, ashes high in alumina such as alumina silicates, alumina, etc.; ashes high in sulfate such as calcium sulfite (CaSO₃) including hannebachite, ashes formed during flue gas desulfurization, gypsum (CaSO₄.2H₂O) etc.; ashes high in calcium such as calcium carbonate, calcium oxide, calcium sulfate, etc.; or any other type of ash or mixtures of ashes that include a mix of ingredients sufficient to form a stabilized red mud suitable as a construction material; and combinations thereof. Exemplary ashes include, without limitation, bed ash from a circulating fluidized bed power plant facility (“CFB bed ash”), fly ash from a circulating fluidized bed power plant facility (“CFB fly ash”), fly ash from a coal fired power plant facility, class C fly ash, class F fly ash, lime kiln dust, cement kiln dust, or similar ashes, and combinations thereof.

As used herein, “class C fly ash” means the finely divided ash combustion residue of coal which meets ASTM C618, Class C. The coal used is typically pulverized and burned, for instance, in power plants. The fly ash is carried off with the gases exhausted from boilers or furnaces in which such coal is burned and is typically recovered by means of suitable precipitation apparatus such as electrostatic precipitators. Typically these ashes are in a finely divided state such that usually at least 70% dry weight passes through a two hundred-mesh sieve.

As used herein, “class F fly ash” means the finely divided ash combustion residue of coal which meets ASTM C618, Class F. Class F is pozzolanic fly ash normally produced from burning anthracite or bituminous coal. The main difference between the class C fly ash and class F fly ash is the amount of calcium, silica (SiO₂), alumina (Al₂O₃), and iron (typically present as Fe₂O₃) content in the ash.

One variety of Class C fly ash that is suitable for inclusion in the ash composition includes Class C fly ash that is a by-product of pulverized coal from the Powder River Basin. Powder River Basin (PRB) coal deposits occur in a well-defined region of northern Wyoming and southern Montana and are used in power generation. The coal which is mined from these deposits is sub-bituminous, i.e., coal of a rank intermediate between bituminous and lignite having caloric values in the range of 8,300 to 13,000 BTU per pound (calculated on a moist, mineral- and matter-free basis). When combusted in power generating plants, PRB coals yield ash that comprises free calcium oxide and amorphous silicates that are cementitious in nature. This variety of Class C fly ash is available from various power generating sites throughout the United States and the Western Hemisphere to include, but not limited to the following partial list: (1) the Fayette Power Plant located in Texas, as supplied by Monex Resources, Inc., Atlanta, Ga.; (2) the Big Cajun Electric Power Plant 2 located in New Roads, La., as supplied by Headwaters Resources, South Jordan, Utah; and (3) the W.A. Parish Power Plant located in Thompsons, Tex., as supplied by Headwaters Resources. Other Class C fly ash source are available on a state by state basis, typically by checking with the particular state's Department of Transportation. For example, the State of Louisiana's Department of Transportation and Development has a list of Fly Ash under the title “Qualified Products List 50,” which is available on the internet.

CFB bed ash and CFB fly ash are solid residues collected from a circulating fluidized bed (CFB) reactor (boiler) wherein a mixture of pulverized fuel, such as coal or coke, and pulverized limestone particles are floated on an air or gas stream and are fluidized proximate to the point of ignition of the fuel. The heat from the combustion of the fuel calcines the limestone particles, thus allowing the subsequent reaction of calcium oxide from the limestone with the SO₂ gases released from the combustion of the fuel. The solid residue which results is carried primarily in the exhaust gases. A portion of this residue is removed as fly ash by a cyclone or other separation device with the remainder being returned to the fluidizing gas stream. The solid residue can also be removed in a coarser form from the bottom of the boiler as bed ash.

The CFB ash suitable for inclusion in the ash composition can be incorporated in either the fly ash or the bed ash form. These CFB fly and bed ashes typically consist of calcium oxide, calcium sulfate, calcium carbonate, and coal ash. Preferred CFB ashes are from a low ash fuel source, such as ash from a petroleum coke fuel source, an example of which is the CFB ash from the Nelson Industrial Steam Company (NISCO) generating station in Westlake, La. as supplied by LA Ash of Sulphur, La. Other CFB ashes suitable for inclusion in the ash composition include ash generated at the AES Shady Point generating station in Panama, Okla. as supplied by Remedial Construction Services, L.P. of Houston, Tex. or Ash Grove Cement Company of Overland Park, Kans.; or that generated at the Formosa Plastics plant in Point Comfort, Tex. as supplied by LA Ash of Sulphur, La.

Another suitable source of CFB fly and CFB bed ash is the JEA Northside Generating Station in Jacksonville, Fla., commercially available under the brand names EZBase and EZSorb. The two circulating fluidized bed (CFB) boilers at the Northside Generating Station are fired with petroleum coke blended with coal. Limestone is added to create thermal mass and as a scrubbing medium to remove sulfurous gases. During the firing process, two by-products are generated: bed ash and fly ash. The fly and bed ash from a solid fuel CFB plant, such as the JEA Northside Generating Station facility, is not the same as a by-product from a conventional boiler that uses pulverized coal or fuel oil. In particular, the JEA's CFB bed ash and fly ash is composed primarily of lime and gypsum (calcium oxides and calcium sulfates, respectively), i.e., over 90% by weight of the JEA CFB by-product is a result of the addition of the limestone to the boilers. That means that less than 10% by weight of JEA's CFB by-product actually represents what would generally be termed “ash” from combustion of the fossil fuels.

The CFB fly ash and CFB bed ash used in the present invention are to be distinguished from prior art Fluidized Bed Combustion (FBC) ash, which has been used as cementitious reagents in a number of ways. First, CFB ash is residue which result from the use of pulverized fuel and limestone sources whereas FBC ash typically results from much coarser starting materials. As a result the CFB materials are powder-like and have much finer average particle sizes (e.g. 0.05 mm average particle size). In direct contrast the prior art FBC ash is much coarser and resembles a uniformly graded sand (e.g., 1.7 mm average particle sizes). It is believed that the finer particle sizes of the CFB ash make it more reactive than the prior art FBC materials. The CFB ash is preferred because of its finer particle sizes, higher sulfur concentrations, and is calcined at lower temperatures/shorter times, is much more reactive than FBC ashes generally, and therefore are highly effective in the stabilization of red mud.

In one embodiment, the ash composition includes a class C fly ash/CFB ash mixture that effectively stabilizes (i.e., physically solidifies) red mud that has a reduced water content into suitable construction material. The class C fly ash and CFB ash are optionally pre-blended and mixed before being intermixed with the red mud. The mixture may comprise the class C fly ash as 30-50% by weight of the mixture and the CFB ash as 50-70% by weight of the mixture. In other embodiments, the proportion of class C fly ash to the CFB ash is in the range of 1:9 to 9:1 on a dry weight basis, preferably 1:3 to 6:1 or 1:2 to 5:1. The CFB ash included in the class C fly ash/CFB ash mixture may be CFB fly ash, CFB bed ash, or mixtures thereof. In one embodiment, the CFB ash is CFB bed ash alone. In another embodiment, the CFB ash is CFB fly ash alone.

When the ash composition is added to the red mud, the ash composition is added in a proportion of at least about 8% by weight relative to the red mud amount selected for stabilization. In another embodiment, the ash composition is added in a proportion of at least 10% by weight relative to the red mud amount selected for stabilization. In another embodiment, the ash composition is added in a proportion of at least 12% by weight relative to the red mud amount selected for stabilization. In another embodiment, the ash composition is added in a proportion of at least 15% by weight relative to the red mud amount selected for stabilization. The minimum amount of ash composition is affected by the water content of the red mud. In one embodiment, the ash composition is about 8% to about 15% by weight relative to the red mud amount selected for stabilization. In another embodiment, the ash composition, when blended with Fluorogypsum or derivatives thereof, is about 5% to about 10% by weight relative to the red mud amount selected for stabilization.

Without being limited to any particular theory, it is believed that the ash composition chemically bonds to the red mud through an exothermic reaction (the heat given off is highly evident) that consumes the free water in the red mud. Further, it is believed that the ash composition reacts with the red mud to form a crystalline structure such as a calcium aluminum sulfate matrix, a calcium silicon sulfate carbonate matrix, or a mixture thereof that may be in the form of an ettringite or ettringite-like structure, a thaumasite or thaumasite-like structure, a sturmanite or sturmanite-like structure, a huangite or huangite-like structure, a minamiite or minamiite-like structure, a creedite or creedite-like structure, or other similar structures capable of taking up water. Ettringite has the formula Ca₆Al₂(SO₄)₃(OH)₁₂.26H₂O. Thaumasite has the formula Ca₃Si(CO₃)(SO₄)(OH)₆.12H₂O, Sturmanite has the formula Ca₆(Fe, Al, Mn)₂(SO₄)₂(B(OH)₄)(OH)₁₂.26H₂O. Huangite has the formula Ca_{0.05}Al₃(SO₄)₂(OH)₆. Minamiite has the formula (NaCaK)Al₃(SO₄)₂(OH)₆. Creedite has the formula Ca₃Al₂SO₄(F,OH)₁₀.2H₂O. The reaction may take up about 10 to 50 moles of water or more, preferably at least 26 moles of water, per mole of red mud.

Also, it should be recognized that other factors may affect the amount of ash composition needed to effectively stabilize the red mud. The factors include, but are not limited to, the pH of the red mud, the volume of red mud to be stabilized and how the shape of the container housing the red mud changes the depth to which the ash composition must be mixed, the ash composition used, and the desired characteristics of the stabilized red mud to be formed.

It has been found that, during the mixing of the ash composition with the red mud, additional water may be added to achieve the desired consistency and chemical reaction. In particular, it has been found that additional water may be needed when adding the ash composition to red mud that has a water content of less than 45%.

Also disclosed herein are methods for stabilizing red mud that has a reduced water content. In one embodiment, the methods include (1) providing a quantity of red mud generated as a by-product of the Bayer process having a reduced water content of less than or equal to about 65%; and (2) mixing an effective amount of an ash composition into the provided quantity of red mud to convert the red mud and its reduced water content into a reaction product suitable as a construction material. The method may also include the step of curing the reaction product until the stabilized red mud has an unconfined compressive strength of about 20 psi to 25 psi. The curing process may take more than 24 hours or more than 2 days, 3 days, 4 days, 5 days, 6 days, 7 days, or more depending upon the volume of red mud being stabilized and the particular ash composition added.

The step of providing a quantity of red mud may include providing a cell within a red mud lake to house a predetermined volume of red mud. The volume of red mud per cell may be between about 100 cubic yards and 500 cubic yards, depending on the volume of ash delivered in truckload quantities. When the red mud is stored in a cell, the mixing of the red mud with the ash composition includes generally thoroughly mixing the two together. This mixing may be performed to a depth of about 2-10 ft. In one embodiment, the red mud and ash are mixed to a depth of six ft. In another embodiment, the red mud and ash are mixed to a depth of 10 ft. The method may also include the step of mixing the red mud housed within the cell to homogenize the red mud, before mixing the red mud with the effective amount of the ash composition. Similar to the other mixing step, the red mud may be homogenized to a depth of 2-10 ft, preferably about 6 ft or 10 ft.

The effective amount of the ash composition is as described above with respect to the composition of the stabilized red mud.

Mixing the ash composition into the red mud can be accomplished by any technique currently known or yet to be invented, but generally heavy duty equipment is used such as mixers, augers, graters, excavators, or other heavy equipment capable of mixing the ash composition into the red mud. Prior to mixing the ash composition into the red mud, the ash composition may be added to the red mud, typically to the surface of the red mud as it is stored in a cell within a red mud pond. The adding of the ash composition can be accomplished by using heavy equipment such as trucks and excavators to transport and dispense the ash. The heavy duty equipment can also include equipment that is capable of both adding and mixing the ash composition with the red mud. Such heavy duty equipment, i.e., earth moving and mixing equipment, is well known in the art and is commercially available from well-known manufacturers.

When the fly ash is added to the red mud, an air filter, water mist, air flow source, a dust containment room or tent, or other air purification methods or devices may be used to remove dust from the air around the application/mixing site. Air quality, especially when fine particles commonly referred to as a “dust” are involved, must be maintained in compliance with government regulations. Therefore, a step of removing free fly ash or dust from the air may be included in the methods disclosed herein.

In another embodiment, the method described above may be modified to include a step of reducing the water content of the red mud to less than or equal to about 50% before mixing the ash composition therewith. The step of reducing the water content may include natural or mechanical means of reducing the water content, such as air drying, increasing an air current across the surface of the red mud, spreading the red mud across a large surface area, heating the red mud, or other known means of drying materials, and combinations thereof. In one embodiment, portions of red mud are removed from a red mud pond and spread over a larger surface area and allowed to air dry. To further increase the rate of drying the red mud may be routinely churned, turned over, tilled, etc.

In another embodiment, the step of reducing the water content may include reducing the water content to about 35-45%, or more preferably to 38-40%. In yet another embodiment, the step of reducing the water content may include reducing the water content to about 25-35%. Once the desired water content is reached, the red mud is typically gathered into one or more pre-determined quantities of red mud for mixing with an effective amount of ash composition so that stabilized red mud suitable as a construction material results. If the red mud is dried to a water content below about 35% as discussed above, the method may include the step of adding additional water if necessary to form a suitable construction material. This method is beneficial because the reduced water content decreases the volume (and weight) of the red mud and makes it easier and cheaper to transport to a construction site. As such, the ash composition may be added to the red mud at the construction site rather than being mixed into a cell in a red mud pond and transported after curing.

There is also the possibility of using the blend of ashes that requires no mechanical blending; it would be mixed directly with the red mud slurry. In this case, the ashes from separate silos or combined ashes in a single silo will feed in-line through a venturi-type mixer, followed by use of in-line static mixers. The amended red mud slurry would be discharged into red mud lakes sectioned off by berms that have weirs in-place. The stabilized solids will fill each bermed area until it reaches the elevation of the weir. After which, amended red mud slurry can be sent to the next bermed area. In essence, bermed areas would become “borrow” pits for future beneficial use of stabilized red mud.

### Example 1

### In-Situ Stabilization of Red Mud

A self-contained cell A was staked in an existing red mud pond to hold 425 cubic yards of red mud having a water content of about 45-65%. Cell A measured 15 ft by 95 ft by 8 ft. The red mud within cell A was mixed with a bucket excavator to a depth of approximately 8 ft to generally homogenize the red mud. A 33/67 blend of class C fly ash/CFB bed ash (a fly ash from the Big Cajun Electric Power Plant, New Roads, La., generated from burning a Powder River Basin (PRB) Coal distributed through Headwaters)/a bed ash from JEA's Northside Generating Station, Jacksonville, Fla., generated from burning a combination of petroleum coke and sub-bituminous coal distributed through Remedial Construction Services, L.P.) was introduced into the red mud in cell A using a pneumatic truck for class C ash and end dump truck for the CFB ash to transfer the ash blend onto the mud surface. The amount of ash blend added to cell A is enough to be 12% by weight of the red mud. An ashing filter was employed to reduce the amount of the ash blend lost as a dust while pneumatically conveying the class C ash. Once the ash blend was introduced to the surface of the red mud, an excavator capable of a soil mixing procedure that can thoroughly mix the ash blend with red mud was used to mix the ash blend with the red mud. Heat in the form of steam was observed as a by-product of the chemical reaction. As a result of the large volume of red mud and the exothermic nature of the reaction, the thoroughly mixed ash and red mud was allowed to cure (and continue to react) for a minimum of 3 days. On day 4, the stabilized red mud was removed from cell A using commercially available excavation equipment.

During the initial 3 day curing process, ground resistance testing was performed on the contents of cell A using a pocket penetrometer and field vane shear test apparatus daily to evaluate that stabilization was ongoing. The results of the testing were as follows:

TABLE 1

| Day | Unconfined Compressive Strength | |
|---|---|---|
| Day 0 | N/A - mixing ash composition with red mud | |
| Day 1 | 10-15 | psi |
| Day 2 | 12.5-17.5 | psi |
| Day 3 | 15-20 | psi |

Pocket penetrometer and field vane shear testing was performed daily. A uni-loader with 12″ diameter auger was used to access this field testing, advancing 2′ in depth. The penetrometer was used to test for shear strength by inserting it 12″ below the surface into the wall of the augured hole ¼″ in a period of 10 seconds. Results of penetrometer testing was recorded in tons per square foot (tsf) and converted to pounds per square inch (psi) by multiplying the tsf result by 2000 pounds per ton and dividing by 144 square inches in one square foot. The field vane shear test was performed on the bottom of the auger hole once loose material is cleaned out from the hole. This test apparatus required the use of a torque wrench. The conversion from inch-pounds to psi was calculated by multiplying inch-pounds by a factor of 0.035823.

### Example 2

### In-situ Stabilization of Red Mud

A self-contained cell B was staked in an existing red mud pond to hold 167 cubic yards of red mud having a water content of about 45-65%. Cell B measured 15 ft by 25 ft by 8 ft. The red mud within cell B was mixed with a bucket excavator to a depth of approximately 8 ft to generally homogenize the red mud. An unblended CFB fly ash (one truckload of fly ash from the AES Puerto Rico power plant, generated from burning a Columbian Coal distributed through Remedial Construction Services, L.P.) was introduced into the red mud in cell B using a pneumatic truck to transfer the ash blend onto the mud surface. The amount of ash, a blend of bed ash and fly ash, added to cell B is enough to be 15% by weight of the red mud. An ashing filter was employed to reduce the amount of the ash blend lost as a dust. Once the ash blend was introduced to the surface of the red mud, an excavator capable of a soil mixing procedure that can thoroughly mix the ash blend with red mud was used to mix the ash blend with the red mud. Heat in the form of steam was observed as a by-product of the chemical reaction. As a result of the large volume of red mud and the exothermic nature of the reaction, the thoroughly mixed ash and red mud were allowed to cure (and continue to react) for a minimum of 3 days. On day 4, the stabilized red mud was removed from cell B using commercially available excavation equipment.

During the initial 3 day curing process, ground resistance testing was performed on the contents of cell B using a pocket penetrometer and field vane shear test apparatus daily to evaluate that stabilization was ongoing. The results of the testing were as follows:

TABLE 2

| Day | Unconfined Compressive Strength |
|---|---|
| Day 0 | N/A - mixing ash composition with red mud |
| Day 1 | 10-15 psi |
| Day 2 | 12-17 psi |
| Day 3 | 14-19 psi |

Pocket penetrometer and field vane shear testing was performed daily. A uni-loader with 12″ diameter auger was used to access this field testing, advancing 2′ in depth. The penetrometer was used to test for shear strength by inserting it 12″ below the surface into the wall of the augured hole ¼″ in a period of 10 seconds. Results of penetrometer testing was recorded in tons per square foot (tsf) and converted to pounds per square inch (psi) by multiplying the tsf result by 2000 pounds per ton and dividing by 144 square inches in 1 ft². The field vane shear test was performed on the bottom of the auger hole once loose material is cleaned out from the hole. This test apparatus required the use of a torque wrench. The conversion from inch-pounds to psi was calculated by multiplying inch-pounds by a factor of 0.035823.

### Example 3

### In-Situ Stabilization of Red Mud

A self-contained cell C was staked in an existing red mud pond to hold 167 cubic yards of red mud having a water content of about 45-65%. Cell C measured 15 ft by 25 ft by 8 ft. The red mud within cell C was mixed with a bucket excavator to a depth of approximately 8 ft to generally homogenize the red mud. An unblended CFB fly ash (one truckload of fly ash from the AES Shady Point power plant located in Panama, Okla., generated from burning a combination of PRB Coal and lignite from the local area, as distributed through Remedial Construction Services, L.P.) was introduced into the red mud in cell C using a pneumatic truck to transfer the ash blend onto the mud surface. The amount of ash, a blend of bed ash and fly ash, added to cell C is enough to be 15% by weight of the red mud. An ashing filter was employed to reduce the amount of the ash blend lost as a dust. Once the ash blend was introduced to the surface of the red mud, an excavator capable of a soil mixing procedure that can thoroughly mix the ash blend with red mud was used to mix the ash blend with the red mud. Heat in the form of steam was observed as a by-product of the chemical reaction. As a result of the large volume of red mud and the exothermic nature of the reaction, the thoroughly mixed ash and red mud were allowed to cure (and continue to react) for a minimum of 3 days. On day 4, the stabilized red mud was removed from cell C using commercially available excavation equipment.

During the initial 3 day curing process, ground resistance testing was performed on the contents of cell C using a pocket penetrometer and field vane shear test apparatus daily to evaluate that stabilization was ongoing. The results of the testing were as follows:

TABLE 3

| Day | Unconfined Compressive Strength |
|---|---|
| Day 0 | N/A - mixing ash composition with red mud |
| Day 1 | 10-15 psi |
| Day 2 | 12-17 psi |
| Day 3 | 14-19 psi |

Pocket penetrometer and field vane shear testing was performed daily. A uni-loader with 12″ diameter auger was used to access this field testing, advancing 2′ in depth. The penetrometer was used to test for shear strength by inserting it 12″ below the surface into the wall of the augured hole ¼″ in a period of 10 seconds. Results of penetrometer testing was recorded in tons per square foot (tsf) and converted to pounds per square inch (psi) by multiplying the tsf result by 2000 pounds per ton and dividing by 144 square inches in 1 ft². The field vane shear test was performed on the bottom of the auger hole once loose material is cleaned out from the hole. This test apparatus required the use of a torque wrench. The conversion from inch-pounds to psi was calculated by multiplying inch-pounds by a factor of 0.035823.

### Example 4

### Ex-situ Stabilization of Red Mud

A self-contained cell D was staked in an existing 6,668 square foot area of dried red mud pond to hold 280 cubic yards of red mud having a water content of about 25-35%. The red mud within cell D was mixed with a soil stabilizer to a depth of approximately 1 ft to generally homogenize the red mud. A 33/67 blend of class C fly ash/CFB bed ash (a fly ash from the Big Cajun Electric Power Plant, New Roads, La., generated from burning a Powder River Basin (PRB) Coal distributed through Headwaters)/a bed ash from JEA's Northside Generating Station, Jacksonville, Fla., generated from burning a combination of petroleum coke and sub-bituminous coal distributed through Remedial Construction Services, L.P.) was introduced into the red mud in cell D using a pneumatic truck for class C ash and end dump truck for the CFB ash to transfer the ash blend onto the mud surface. The amount of ash blend added to cell D is enough to be 12% by weight of the red mud. An ashing filter was employed to reduce the amount of the ash blend lost as a dust while pneumatically conveying the class C ash. Once the ash blend was introduced to the surface of the red mud, the soil stabilizer capable of a soil mixing procedure that can thoroughly mix the ash blend with red mud was used to mix the ash blend with the red mud while adding 10% water by weight through the stabilizer. The thoroughly mixed ash and red mud were allowed to cure (and continue to react) for a minimum of 3 days. On day 4, the stabilized red mud was rolled with a steel drum compactor to seal the surface to serve as a foundation for a stabilized red mud levee.

During the initial 3 day curing process, ground resistance testing was performed on the contents of cell A using a pocket penetrometer and field vane shear test apparatus daily to evaluate that stabilization was ongoing. The results of the testing were as follows:

TABLE 4

| Day | Unconfined Compressive Strength | |
|---|---|---|
| Day 0 | N/A - mixing ash composition with red mud | |
| Day 1 | 10-15 | psi |
| Day 2 | 12.5-17.5 | psi |
| Day 3 | 15-20 | psi |

Pocket penetrometer and field vane shear testing was performed daily. A uni-loader with 12″ diameter auger was used to access this field testing, advancing 12″ in depth. The penetrometer was used to test for shear strength by inserting it 6″ below the surface into the wall of the augured hole ¼″ in a period of 10 seconds. Results of penetrometer testing was recorded in tons per square foot (tsf) and converted to pounds per square inch (psi) by multiplying the tsf result by 2000 pounds per ton and dividing by 144 square inches in 1 ft². The field vane shear test was performed on the surface next to the auger hole. This test apparatus required the use of a torque wrench. The conversion from inch-pounds to psi was calculated by multiplying inch-pounds by a factor of 0.035823.

### Example 5

### Levee 1

The stabilized red mud that was excavated from cell A after the three day cure was transported to a site for construction of a levee, Levee 1. Transportation may be by any appropriate means such as a dump truck, barge, etc. Financial considerations contribute to the means chosen. Levee 1 was constructed to be 140 ft along the top with a 10 ft wide crown, 8 ft high, with a 3:1 slope on the outboard side and a 2:1 slope on the inboard side. The levee was constructed by spreading stabilized red mud in 1′ in-place lifts using a dozer with low ground pressure tracks. A steel drum compactor was used to seal each horizontal lift without the need of the vibratory effect.

### Example 6

### Levee 2

The stabilized red mud that was excavated from cell B after the 3 day cure was transported to a site for construction of Levee 2. Transportation may be by any appropriate means such as a dump truck, barge, etc. Financial considerations contribute to the means chosen. Levee 2 was constructed from the stabilized red mud to be 90 ft along the top with a 10 ft wide crown, 8 ft high, with a 3:1 slope on the outboard side and a 2:1 slope on the inboard side. The levee was constructed by spreading stabilized red mud in 1′ in-place lifts using a dozer with low ground pressure tracks. A steel drum compactor was used to seal each horizontal lift without the need of the vibratory effect.

### Example 7

### Levee 3

The stabilized red mud that was excavated from cell C after the three day cure was transported to a site for construction of Levee 3. Transportation may be by any appropriate means such as a dump truck, barge, etc. Financial considerations contribute to the means chosen. Levee 3 was constructed from the stabilized red mud to be 90 ft along the top with a 10 ft wide crown, 8 ft high, with a 3:1 slope on the outboard side and a 2:1 slope on the inboard side. The levee was constructed by spreading stabilized red mud in 1′ in-place lifts using a dozer with low ground pressure tracks. A steel drum compactor was used to seal each horizontal lift without the need of the vibratory effect.

Data for Levees 1-3

TABLE 3

| Properties Tested | Levee 1 | | Levee 2 | | Levee 3 | |
|---|---|---|---|---|---|---|
| UCS @ 28-day | 20-25 | psi | 15-20 | psi | 15-20-psi | |
| Permeability @ 28-day | <1 × 10⁻⁷ | cm/sec | <1 × 10⁻⁷ | cm/sec | <1 × 10⁻⁷ | cm/sec |
| Pinhole Dispersion | ND-1 | | ND-1 | | ND-1 | |
| (Erodibility) @ 28-day | | | | | | |
| Bulk Density @ 28-day | 112 | pcf | 114 | pcf | 116 | pcf |

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

What is claimed:

1. A stabilized red mud composition comprising:
red mud generated as a by-product of the Bayer process reduced to a water content of less than or equal to about 65%; and
an effective amount of an ash composition to convert the red mud and its water content into a reaction product suitable as a construction material.

2. The composition of claim 1, wherein the ash composition comprising ash selected from the group consisting of ash high in alumina, ash high in sulfate, ash high in calcium, and combinations thereof.

3. The composition of claim 1, wherein the ash composition comprises a CFB bed ash, a CFB fly ash, fly ash from a coal fired power plant facility, a class C fly ash, Portland cement, lime kiln dust, cement kiln dust, cement-lime, class C fly ash-lime and combinations thereof.

4. The composition of claim 3, wherein the ash composition comprises a mixture of the class C fly ash and either the CFB bed ash or the CFB fly ash.

5. The composition of claim 4, wherein the class C fly ash comprises about 30% to about 50% of the ash composition and the CFB bed ash or the CFB fly ash comprises the remaining about 50% to about 70% of the ash composition.

6. The composition of claim 4, wherein the CFB bed ash or CFB fly ash are a by-product of petroleum coke, petroleum coke blended with coal and limestone added for sulfur capture.

7. The composition of claim 1, wherein the red mud has a water content of about 50% to about 65%.

8. The composition of claim 1, wherein the red mud has a water content of about 25% to about 50%.

9. A method of making a stabilized red mud composition, the method comprising:
providing a quantity of red mud generated as a by-product of the Bayer process having a reduced water content of less than or equal to about 65%; and
mixing an effective amount of an ash composition into the provided quantity of red mud to convert the red mud and its reduced water content into a reaction product suitable as a construction material.

10. The method of claim 9, further comprising curing the reaction product until the stabilized red mud has a resistant strength of about 20-psi to 25-psi.

11. The method of claim 9, wherein providing a quantity of red mud includes providing a cell within a red mud pond housing a predetermined volume of red mud, the method further comprising mixing the red mud housed within the cell to homogenize the red mud before mixing the red mud with the effective amount of the ash composition.

12. The method of claim 9, wherein the ash composition comprises a CFB bed ash, a CFB fly ash, fly ash from a coal fired power plant facility, a class C fly ash, lime kiln dust, cement kiln dust, Portland cement, cement-lime, class C fly ash-lime, and combinations thereof.

13. The method of claim 9, wherein the ash composition comprises a mixture of the class C fly ash and either the CFB bed ash or the CFB fly ash, wherein the class C fly ash comprises 30-50% of the ash composition and the CFB bed ash or the CFB fly ash comprises the remaining 50-70% of the ash composition.

14. The method of claim 13, wherein the CFB bed ash or CFB fly ash are a by-product of petroleum coke, petroleum coke blended with coal and limestone added for sulfur capture.

15. The method of claim 9, wherein the red mud has a water content of about 50% to about 65%.

16. The method of claim 15, further comprising the step of reducing the water content of the red mud to about 25% to about 50%.

17. The method of claim 16, wherein reducing the water content includes spreading the red mud across a surface to dry, the method further comprising gathering the air dried red mud into the quantity of red mud for mixing with the effective amount of the ash composition.

18. A water level regulating structure comprising:
a stabilized red mud comprising:
a red mud generated as a by-product of the Bayer process reduced to a water content of less than or equal to about 65%; and
an effective amount of an ash composition to convert the red mud and its water content into a reaction product suitable as a construction material.

19. A landfill material comprising:
a stabilized red mud comprising:
a red mud generated as a by-product of the Bayer process reduced to a water content of less than or equal to about 65%; and
an effective amount of an ash composition to convert the red mud and its water content into a reaction product suitable as a construction material.
